(19) United States
(12) Patent Application Publication
(10) Pub. No.: US 2024/0401384 A1
(43) Pub. Date: Dec. 5, 2024

(54) LINEARLY DRIVEN ROTARY LOCKING MECHANISM

(71) Applicant: Kam Lin May CHEUNG, N.T., Hong Kong (HK)

(72) Inventor: Kam Lin May CHEUNG, N.T., Hong Kong (HK)

(21) Appl. No.: 18/801,595

(22) Filed: Aug. 12, 2024

Related U.S. Application Data
(63) Continuation of application No. 17/655,551, filed on Mar. 20, 2022.

(51) Int. Cl. E05C 3/06; E05B 47/00

(52) U.S. Cl. CPC E05C 3/06; E05B 47/0001

(57) ABSTRACT

Disclosed is a linearly driven rotary locking mechanism comprising: a rotating lock hook (1), a rotating member (3), a biasing force device (5), a slider (7), turntables (9, 14) and a reset mechanism (11), the rotating shaft (4) of the rotating member (3) is secured with the biasing force device (5) and the biasing force device (5) can rotate about the rotating shaft (6) of the biasing force device (5), the turntables (9, 14) and the reset mechanism (11) are respectively capable of rotating about their respective rotating shaft, and the turntables (9, 14) and the reset mechanism (11) are designed for local contact with the slider (7), wherein the rotating lock hook (1) and the rotating member (3) can rotationally mesh with each other, and the slider (5) can linearly slide, and the rotary locking and rotary unlocking of the rotary locking mechanism are driven by the linear sliding of the slider (7).

### CROSS-REFERENCE TO RELATED APPLICATION(S)

This application is a continuation of the U.S. application Ser. No. 17/655,551 filed on 20 Mar. 2022, and entitled “Linearly Driven Rotary Locking Mechanism”, which is a continuation of International Patent Application No. PCT/CN2020/104877, filed on Jul. 27, 2020, the entire contents of which are incorporated herein by reference.

### TECHNICAL FIELD

The present application relates to a linearly driven rotary locking mechanism especially used in swing doors or sliding doors.

### BACKGROUND

Swing doors or sliding doors are common design forms of home or commercial doors.

Usually, swing doors or sliding doors are locked by rotating thumb turn action. In other words, the rotary locking of swing doors or sliding doors is driven by the rotational movement of fingers. Small locking force and large unlocking force required of such locking mechanism leads to poor reliability of locking operation, complex mechanical transmission mechanism and high jam risk, resulting in the situation where the door cannot be opened. Moreover, it is not ergonomically friendly.

The technical problem to be solved by the present application is to provide a linearly driven rotary locking mechanism with small unlocking force, reliable locking and simple operation.

### SUMMARY

The technical problem to be solved by the present application is solved through a linearly driven rotary locking mechanism, wherein the rotary locking mechanism comprises a rotating lock hook, a rotating member, a biasing force device, a slider, turntables and a reset mechanism, the rotating shaft of the rotating member is secured with the biasing force device and the biasing force device can rotate about the rotating shaft of the biasing force device, the turntables and the reset mechanism are respectively capable of rotating about their respective rotating shaft, and the turntables and the reset mechanism are designed for local contact with the slider, wherein the rotating lock hook and the rotating member can rotationally mesh with each other, and the slider can linearly slide, and the rotary locking and rotary unlocking of the rotary locking mechanism are driven by the linear sliding of the slider. The rotary locking mechanism of the present application has the advantages of small unlocking force, reliable locking and simple operation.

The slider preferably has a boss protruding upwards. The rotating member preferably has a projecting strip protruding downwards, and the lower end of the rotating member preferably has a recess recessed toward the inside of the rotating member on the right side of the projecting strip. In particular preferably, in the locked state, the boss is under the projection strip, and in the unlocked state, the recess accommodates the boss. The locking is reliable because the projection strip is “stayed” on the boss in the locked state to maintain the rotary locking mechanism according to the present application in the locked state. Accordingly, because of the specific shapes of the projection strip and the boss, the naturally occurred friction force that needs to be overcome is comparatively small. Meanwhile, the rotary locking mechanism according to the present application is maintained in the unlocked state thanks to the shape fit of the boss and the recess.

Preferably, the boss is designed in a prismoid shape. And in particular preferably, the boss is designed with a concave upper surface. Therefore, the shapes of the slider and the rotating member can be better fitted, and a better frictional engagement can be achieved.

Moreover, the slider is provided with two projecting portions facing each other extending downwards along the outer surface of the slider, and a blocking portion of the slider is provided between the two projecting portions such that guide rails are formed between the projecting portions and the blocking portion. Preferably, the rotary locking mechanism has two turntables which are respectively preferably designed with cams protruding from the side edge of the corresponding turntable, and two gear discs are arranged coaxially with the two turntables between the two turntables, and the two turntables and the two gear discs are respectively supported on the rotating shaft in a rotatable manner, in addition, the two turntables and the two gear discs form two synchronously rotating sets each comprising one turntable and one gear disc. More preferably, the slider and/or the two turntables are respectively designed to be able to be manually driven or electrically driven. Therefore, the slider may be driven manually, electrically, or the linear sliding, i.e., locking movement of the slider may be alternatively or additionally (and/or) by the rotational movement of one or both turntables. That is to say, the mode of operation for driving the locking of the rotary locking mechanism according to the present application may be one or more of the following modes of operation or a combination thereof:
manually driving the slider, and/or
electrically driving the slider, and/or
manually driving the rotary motion of one or more turntables, and/or
electrically driving the rotary motion of one or more turntables.

the reset mechanism is designed as a turntable with a pushrod, and the pushrod is designed for contact with the blocking portion of the slider. A handle is arranged and fixed at the center of the reset mechanism, and the handle is designed to rotate the turntable. The handle is particularly preferably designed to project from the door to facilitate the user to operate the sliding and opening and closing of the door. Therefore, the slide may be driven manually and/or electrically or the linear slide to the right, i.e., the unlocking movement of the slider may be driven by turning the handle by the user. In other words, other modes of operation of driving the sliding of the slider, i.e., driving the rotary unlocking of the rotary locking mechanism according to the present application can be provided by rotating the handle.

The biasing force device is preferably a torsion spring. The torsion spring is easy to install and replace, thus saving materials or other costs.

Therefore, the rotary locking mechanism according to the present application provides different modes of locking and unlocking operation, and the rotary locking mechanism according to the present application has the advantages of small unlocking force, reliable locking and simple operation.

The terms “up”, “down”, “left” and “right” as well as “bottom” and “top” are used herein and below for the sake of convenience for description only and are not intended to be limited to any single location or spatial orientation unless otherwise stated.

Herein and below, the terms “a” and “an” in the present application do not denote a limitation of quantity, but rather denote the presence of at least one of the referenced items.

### BRIEF DESCRIPTION OF THE DRAWINGS

The advantages, features and characteristics of the present application as well as the ways and methods of achieving them are further described below with reference to the accompanying drawings and embodiments. In the drawings:

FIG. 1 shows a locking schematic diagram of a linearly driven rotary locking mechanism according to the present application in the locked state;

FIG. 2a shows a perspective view from a left front view of the rotary locking mechanism according to FIG. 1 in the locked state;

FIG. 2b shows a perspective view from a right front view of the rotary locking mechanism according to FIG. 1 in the locked state;

FIG. 3 shows an unlocking schematic diagram of the linearly driven rotary locking mechanism according to the present application in the unlocked state;

FIG. 4a shows a perspective view from a left front view of the rotary locking mechanism according to FIG. 3 in the unlocked state;

FIG. 4b shows a perspective view from a right front view of the rotary locking mechanism according to FIG. 3 in the unlocked state;

In the drawings, the same reference numerals are set for the identical elements throughout drawings and repeated descriptions of these elements are omitted.

The illustrations reproduced in the drawings and embodiments of the present application are described in detail below.

### REFERENCE NUMERAL LIST

1 rotating lock hook
2 rotating shaft
3 rotating member
3a projection strip
3b recess
4 rotating shaft
5 biasing force device
6 rotating shaft
7 slider
7a boss
7b projecting portion
7c blocking portion
8 slide pin
9, 14 turntables
9a, 14a cams
10 rotating shaft
11 turntable/reset mechanism
11a pushrod
12 handle
13, 15 gear discs

### DETAILED DESCRIPTION

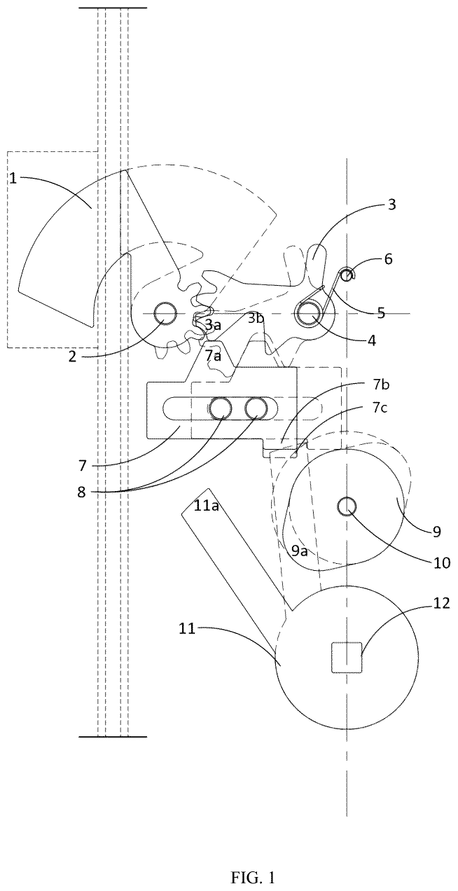

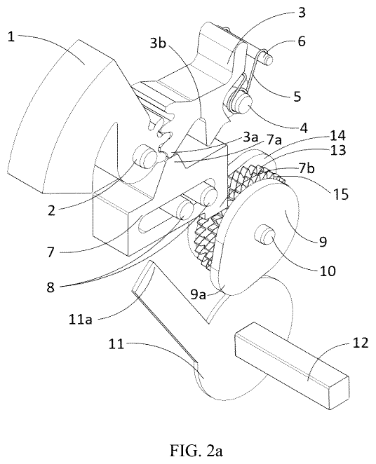

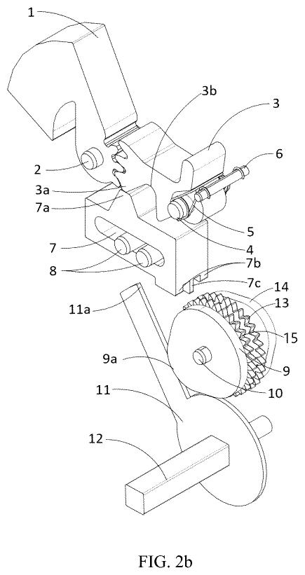

With reference to FIGS. 1 to 4b, the locking principle in the locked state and the structural design scheme of the linearly driven rotary locking mechanism according to the present application will be described in detail below. A portion of a door frame or other sliding door and a lockbox therein for accommodating a rotating lock hook 1 are shown in dashed lines on the left side of FIG. 1. An edge opening portion of the door frame or other sliding doors at the lockbox fits in shape with the lower side of the hook-shaped end of the rotating lock hook 1. In other words, the rotating lock hook 1 is designed with a hook-shaped end having a cavity fitting in shape with the edge opening portion of the door frame or other sliding doors such that the hook-shaped end hooks the edge opening portion of the door frame or other sliding door in the locked state in order to maintain the locking of the rotating lock hook 1 with the door frame or other sliding doors. The rotating lock hook 1 is rotatable about a rotating shaft 2 and the rotating lock hook is provided with a toothed end protruding to the right at the end away from the hook-shaped end.

One end of the rotating member 3 is designed with a pairing end protruding to the left and capable of engaging with the toothed end of the rotating latch hook 1, the pairing end having a plurality of pairing teeth, and the lowermost pairing tooth having a projection strip 3a projecting downwards. The other end of the rotating member 3 is rotatably connected to a rotating shaft portion 4, and the rotating shaft portion 4 of the rotating member 3 is secured with a biasing force device 5 and the biasing force device 5 is rotatable about a rotating shaft 6 of the biasing force device 5. The biasing force device 5 is, for example, a torsion spring. Here, the rotating shaft portion 4 may be a rotating shaft passing through the rotating member 3, or the rotating shaft portion 4 may be designed, for example, in a roller shape about whose outer surface the rotating member 3 rotates, that is, the rotating shaft portion 4 is a separate roller. In addition, it should be understood here that the rotating shaft is any member about which the rotating member rotates at the rotating shaft 4. The biasing force device 5 is designed for winding the rotating shaft portion 4 and the rotating shaft 6. In the case where the rotating shaft portion 4 is a rotating shaft passing through the rotating member 3, the biasing force device 5 wraps the portion of the rotating shaft portion 4 projecting from the rotating member 3. Alternatively, in the case where the rotating shaft portion 4 is a separate roller, the end of the rotating member 3 is designed to fit in shape with the rotating shaft 4 so that the rotating member 3 can rotate around the outer surface of the rotating shaft portion 4, and the biasing force device 5 is partially wound around the outer surface of the rotating shaft portion 4 and does not interfere with the rotation of the rotating member 3. In this case, when a failure occurs, the biasing force device 5 can be separately replaced without replacing the entire rotating member 3, thereby facilitating maintenance and saving materials and costs.

The lower end of the rotating member 3 is provided with a recess 3b recessed toward the inside of the rotating member 3 on the right side of the projection strip 3a.

Preferably, the rotating shaft 2 and the rotating shaft 4 are arranged on the same horizontal plane.

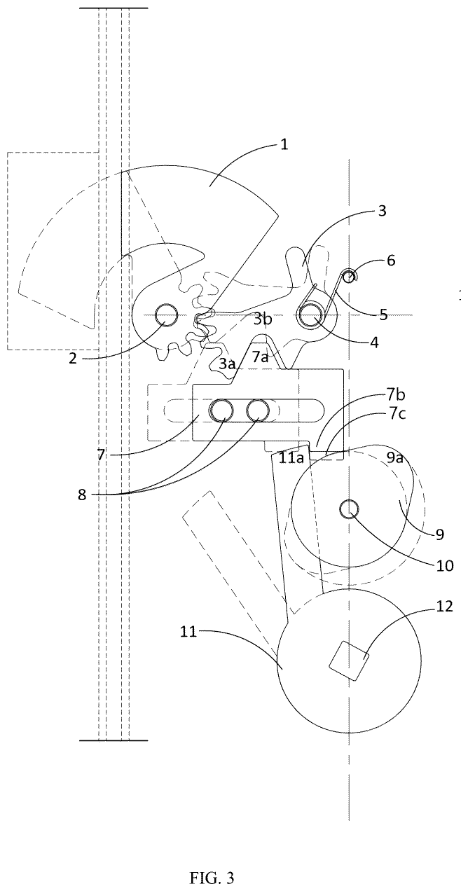

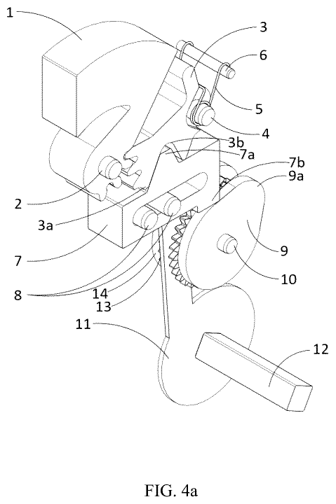

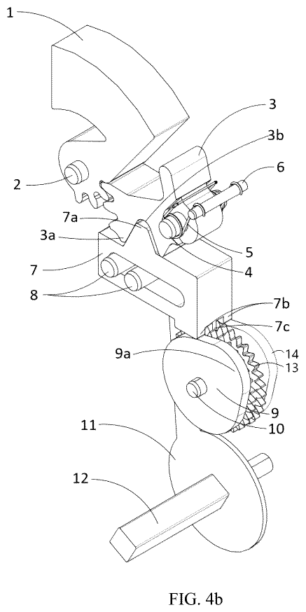

A slider 7 is arranged below the rotating lock hook 1 and the rotating member 3. The upper surface of the slider is designed with a boss 7a protruding upwards which is designed to fit in shape with the recess 3b of the rotating member 3 as clearly shown in FIGS. 3 to 4b. Preferably, the boss 7a is designed integrally in a prismoid shape. Preferably, the boss 7a is designed with a concave upper surface. Preferably, the boss 7a can be designed to be integrally formed with slider 7. In addition, a slotted hole is provided in the middle of slider 7 along the longitudinal direction of slider 7. The slotted hole preferably penetrates slider 7 in the transverse direction, but it is not essential. A slide pin 8 is arranged in the slotted hole. The position of slide pin 8 in the spatial coordinates remains unchanged, however, slider 7 is capable of sliding relative to slide pin 8. That is, slider 7 is supported in the slotted hole by slide pin 8. Since the diameter of slide pin 8 substantially coincides with the slot height of the slotted hole and the slotted hole has a specific length, slider 8 is restricted by the slotted hole to perform a linear reciprocating motion with a certain length. Preferably, there are one or more slide pins 8. The lower right end of slider 7 is provided with two projecting portions 7b facing each other extending downwards along the outer surface of slider 7. A blocking portion 7c extending downwards from slider 7 is provided between the two projecting portions 7b such that guide rails are formed between the respective projecting portions 7b and the blocking portion 7c, respectively. The guide rails can be designed with a straight line, arc or stepped shapes.

Two turntables 9, 14 are arranged below slider 7. The turntables 9 and 14 have cams 9a and 14a respectively. The turntables 9, 14 are preferably designed in the shape of discs, and the cam 9a protrudes from the side edge of the turntable 9. The turntables 9, 14 are rotatable about a rotating shaft 10 provided at the center of the disc. That is, turntables 9 and 14 are respectively rotatably supported on the rotating shaft 10. Preferably, the cam 9a is designed to be integrally formed with the turntable 9. Preferably, the edge side of cam 9a is designed to be arc-shaped. Two gear discs 13, 15 are arranged coaxially between the turntables 9, 14 sequentially, wherein the two gear discs 13, 15 are respectively supported on the rotating shaft 10 in a rotatable manner. In addition, the turntable 9 and the gear disc 15 are designed to rotate synchronously and the turntable 14 and the gear disc 13 are designed to rotate synchronously. That is, the two turntables 9, 14 and the two gear discs 13, 15 form two synchronously rotating sets each comprising one turntable and one gear disc. In addition, the dimensions of the turntables 9, 14 and the gear discs 13, 15 are designed as a whole in a way that the outer surfaces on both sides of the turntable 9 and 14 are respectively in the same plane as the outer surfaces on both sides of the slider 7, so that the cams 9a, 14a of the turntables 9, 14 may respectively contact with the two projecting portions 7b of the slider 7, and the gear discs 13, 15 are designed to be capable of respective contact with the guide rails of the slider 7, so that the gear discs 13, 15 are accommodated in the guide rails in the unlocked state without affecting the contact between the turntables 9, 14 and the projecting portions 7b of the slider 7. In other words, the guide rails of slider 7 are designed to accommodate the gear discs 13, 15. A turntable 11 with a pushrod 11a is provided below the turntable 9. The pushrod 11a is a straight rod extending outwards from a portion of the turntable 11, and the depth of the turntable 11 in space (i.e. the depth direction toward the inside of the papers in FIGS. 1 and 3) and the length of the pushrod 11a are designed to enable the contact with the blocking portion of the slider 7 in the unlocked state. Preferably, the turntable 11 is designed to be substantially disc-shaped. The turntable 11 is sized so as not to affect the rotation of the turntable 9, i.e., the outer edge of the turntable 11 does not contact the outer edge of the turntable 9. A handle 12 is provided and held at the center of the turntable 11, and handle 12 is not rotationally connected to the turntable 9. The handle 12 is designed to rotate the turntable 11. Moreover, handle 12 is designed to project from the sliding door (not shown) towards the user to facilitate the operation of sliding as well as opening and closing of the sliding door.

Preferably, turntables 9, 14 and/or slider 7 can be driven manually or electrically.

Preferably, the rotating shaft 10 and the handle 12 are arranged concentrically, i.e., the centers of the rotating shaft 10 and the handle 12 are in the same vertical line.

Preferably, the rotary locking mechanism according to the present application is integrally concealed in the sliding door except for the handle 12, that is, the thickness of the rotary locking mechanism according to the present application is designed to be smaller than the thickness of the door except for the portion of the handle 12 designed to extend out of the sliding door, and the rotary locking mechanism according to the present application is sized to enable concealing or accommodating in the door.

Preferably, handle 12 is ergonomically designed and suitable for use by a user.

Hereinafter, the specific opening and closing principle of the rotary locking mechanism according to the present application described above will be described in detail with reference to FIGS. 1 and 3. First, in FIGS. 1 and 3, respectively, the locked state and the unlocked state of the rotary locking mechanism according to the present application are shown in solid lines, and the unlocked state and the locked state of the rotary locking mechanism according to the present application are shown in dashed lines, thereby showing the opening and closing principle of the rotary locking mechanism according to the present application.

The rotary locking mechanism in FIG. 1 changes from the unlocked state to the locked state (from the dashed line to the solid line). During the transition from the unlocked state to the locked state, slider 7 slides linearly in the direction of the door frame or other sliding doors. Since the boss 7a of the slider 7 and the recess 3b of the rotating member 3 fits in shape and the rotating member 3 can rotate and move about the rotating shaft 4, the rotating member 3 rotates clockwise about the rotating shaft 4 with the linear sliding of the slider 7. Since the mating teeth of the rotating member 3 engage with the toothed end of the rotary lock hook 1, the rotary movement of the rotating member 3 causes the rotary lock hook 1 to rotate counterclockwise about the rotating shaft 2, so that the hook-shaped end of the rotary lock hook 1 engages with the edge opening portion of the door frame or other sliding doors (shown in dashed lines) in the locked state. In the locked state, due to the clockwise rotation of the rotating member 3, the biasing force device 5 is compressed and thus has a certain pre-tightening force/biasing force. In other words, the rotary locking of the rotary locking mechanism according to the present application is driven by the linear sliding of slider 7. When the boss 7a is positioned under the projection strip 3a of the rotating member 3, the biasing force device 5 provides the maximum pre-tightening force, and the hook-shaped end of the rotating lock hook 1 hooks the door frame or other sliding doors, completing the locking action. Since the projection strip 3a is supported by the upper surface of the boss 7a and it is, therefore, sufficient to withstand the gravity of the rotating member 3 itself and the pre-tightening force of the biasing force device 5, the locked state can be maintained. In other words, since the boss 7a has a flat or preferably recessed upper surface in contact with the projection strip 3a of the rotating member 3, it is impossible for the boss 7a itself to generate any force in the horizontal direction to slide the slider 7 without any other external force in the locked state so that the locked state can be reliably maintained.

Alternatively, or additionally, during the transition from the unlocked state to the locked state, the cam 9a of the turntable 9 and/or the cam 14a of the turntable 14 pushes the projecting portions 7b of slider 7 so that slider 7 slides horizontally to the left and drives the linear movement of the above-mentioned slider 7, thereby driving the locking function. In other words, as an alternative or additional locking mode, horizontal sliding of slider 7 is driven by the rotational movement of the turntable 9 and/or the turntable 14. Since slider 7 horizontally slides to the left, the blocking portion 7c of slider 7 naturally pushes the pushrod 11a and causes the turntable 11 to rotate counterclockwise.

Here, it should be noted that the rotary locking mechanism according to the present application is driven essentially by linear sliding of slider 7. Further, the linear sliding, i.e. locking movement of the slider 7 may be driven manually, electrically, or alternatively or additionally (and/or) by the rotational movement of one or both of the turntables 9, 14, and the rotational movement of one or both of the turntables 9, 14 may also be triggered manually or electrically, respectively. Turntables 9, 14 do not have to rotate synchronously. In other words, The turntables 9, 14 can be rotated independently of each other about the rotating shaft 10, thereby in the case where the turntables 9, 14 are used to drive the linear sliding of the slider 7, only one of the turntables 9, 14 needs to be rotated, and the other turntable may have a driving function to drive the slider 7 to slide linearly to lock the next time (i.e. the two turntables 9, 14 are designed to drive the linear sliding of the slider 7 alternately) or have an auxiliary function in case of failure.

The rotary locking mechanism in FIG. 3 changes from the locked state to the unlocked state (from the dashed line to the solid line). Here, slider 7 is horizontally slid to the right until the boss 7a of slider 7 enters the recess 3b of the rotating member 3. Due to the gravity of the rotating member 3 itself and the release of the pre-tightening force of the biasing force device 5, the rotating member 3 rotates counterclockwise and rotates the rotating lock hook 1 clockwise through the mating teeth meshing with the teeth of the rotating lock hook 1, thereby leaving the door frame or other sliding doors to complete the unlocking. In other words, the rotary unlocking of the rotary locking mechanism according to the present application is driven by the linear sliding of slider 7.

In addition, during the unlocking process, the projecting portions 7b of the slider 7 naturally abut against the corresponding cams 9a, 14a of the turntable 9 and/or the turntable 14, and the guide rails of slider 7 accommodate the gear discs 13, 15.

The user can rotate the handle 12 so that the turntable 11 rotates clockwise consequentially, and the pushrod 11a further pushes the blocking portion 7c of slider 7 to the right so that the slider 7 slides horizontally to the right and performs the aforementioned unlocking action to achieve the unlocking effect. Therefore, the turntable 11 with the pushrod 11a can also be referred to as a reset mechanism of the rotary locking mechanism according to the present application.

Here, it should be noted that the horizontal slider to the right, i.e., the unlocking movement of slider 7 may be driven manually and/or electrically or by turning the handle 12 by the user.

Although the present application has been described with reference to embodiments, various changes may be made to the elements, members and components of the present application by those skilled in the art and may be replaced with equivalent forms without departing from the claimed scope of the present application. In addition, the present application is not limited to the particular embodiments disclosed as the best mode for carrying out the present application, instead, the present application will cover all embodiments within the claimed scope.

1. A linearly driven rotary locking mechanism comprising: a rotating lock hook (1), a rotating member (3), a biasing force device (5), a slider (7), turntables (9, 14) and a reset mechanism (11), wherein the rotating shaft portion (4) of the rotating member (3) is secured with the biasing force device (5) and the biasing force device (5) can rotate about the rotating shaft (6) of the biasing force device (5), the turntables (9, 14) and the reset mechanism (11) are respectively capable of rotating about their respective rotating shaft, and the turntables (9, 14) and the reset mechanism (11) are designed for local contact with the slider (7), characterized in that the rotating lock hook (1) and the rotating member (3) can rotationally mesh with each other, and the slider (5) can linearly slide, and the rotary locking and rotary unlocking of the rotary locking mechanism are driven by the linear sliding of the slider (7).

2. The rotary locking mechanism according to claim 1, characterized in that,
the slider (7) has a boss (7a) protruding upwards.

3. The rotary locking mechanism according to claim 1, characterized in that,
the rotating member (3) has a projection strip (3a) protruding downwards, the lower end of the rotating member (3) is provided with a recess (3b) recessed toward the inside of the rotating member (3a) on the right side of the projection strip (3a), preferably, in the locked state, the boss (7a) is under the projection strip (3a), and in the unlocked state, the recess (3b) accommodates the boss (7a).

4. The rotary locking mechanism according to claim 2, characterized in that,
the boss (7a) is designed in a prismoid shape, and preferably, the boss (7a) is designed with a concave upper surface.

5. The rotary locking mechanism according to claim 1, characterized in that,
the slider (7) is provided with two projecting portions (7b) facing each other extending downwards along the outer surface of the slider (7), a blocking portion (7c) of the slider (7) is provided between the two projecting portions (7b) such that guide rails are formed between the projecting portions 7b and the blocking portion 7c.

6. The rotary locking mechanism according to claim 5, characterized in that,
the rotary locking mechanism has two turntables (9, 14) which are respectively designed with cams (9a, 14a) protruding from the side edge of the corresponding turntable, and two gear discs (13, 15) are arranged coaxially with the two turntables (9, 14) between the two turntables (9, 14), and the two turntables (9, 14) and the two gear discs (13, 15) are respectively supported on the rotating shaft (10) in a rotatable manner, in addition, the two turntables (9, 14) and the two gear discs (13, 15) form two synchronously rotating sets each comprising one turntable and one gear disc.

7. The rotary locking mechanism according to claim 6, characterized in that,
the slider (7) and/or the two turntables (9, 14) are respectively designed so as to be able to be manually driven or electrically driven.

8. The rotary locking mechanism according to claim 5, characterized in that,
the reset mechanism (11) is designed as a turntable (11) with a pushrod (11a), and the pushrod (11a) is designed for contact with the blocking portion (7c) of the slider (7).

9. The rotary locking mechanism according to claim 8, characterized in that,
a handle (12) is arranged and fixed at the center of the reset mechanism (11), the handle (12) being designed to rotate the turntable (11).

10. The rotary locking mechanism according to claim 1, characterized in that,
the biasing force device (5) is a torsion spring.
